(19) United States
(12) Patent Application Publication
(10) Pub. No.: US 2025/0110313 A1
(43) Pub. Date: Apr. 3, 2025

(54) OPERATION RING, LENS DEVICE, AND METHOD OF MANUFACTURING OPERATION RING

(71) Applicant: FUJIFILM Corporation, Tokyo (JP)

(72) Inventor: Nobuyuki KONDO, Saitama (JP)

(73) Assignee: FUJIFILM Corporation, Tokyo (JP)

(21) Appl. No.: 18/979,536

(22) Filed: Dec. 12, 2024

Related U.S. Application Data
(63) Continuation of application No. PCT/JP2023/021745, filed on Jun. 12, 2023.

(30) Foreign Application Priority Data
Jun. 17, 2022 (JP) 2022-098403

(51) Int. Cl. G02B 7/10; G02B 15/14

(52) U.S. Cl. CPC G02B 7/10; G02B 15/14

(57) ABSTRACT

A lens barrel includes a zoom ring, an optical system, and an electric zoom mechanism that drives a zoom lens group that is a part of the optical system, in accordance with rotation of the zoom ring. The zoom ring includes a ring member, a first recess portion formed in the ring member, and plating applied to the first recess portion, and an inclined part is formed in the first recess portion.

### CROSS-REFERENCE TO RELATED APPLICATIONS

This application is a Continuation of PCT International Application No. PCT/JP2023/021745 filed on 12 Jun. 2023, which claims priority under 35 U.S.C § 119 (a) to Japanese Patent Application No. 2022-098403 filed on 17 Jun. 2022. The above application is hereby expressly incorporated by reference, in its entirety, into the present application.

### BACKGROUND OF THE INVENTION

### 1. Field of the Invention

The present invention relates to an operation ring, a lens device, and a method of manufacturing an operation ring.

### 2. Description of the Related Art

JP2021-071541A (corresponding to US2021/0124142A1) describes an imaging apparatus including an optical member, a focus motor for moving the optical member, a lens CPU that controls the focus motor, a manual focus ring including a reflective portion and a low reflective portion, and a photoreflector that receives light reflected by the reflective portion. The lens CPU controls the focus motor in accordance with the output from the photoreflector.

A lens device disclosed in JP6973398B comprises an operation ring that is rotated, a light-emitting element that emits light, and a plurality of light-receiving elements, and is provided with a detection pattern portion having a reflective surface and a non-reflective surface that are alternately disposed in a rotation direction of the operation ring and that move with the rotation of the operation ring. The light-emitting element emits the light to the detection pattern portion. The plurality of light-receiving elements are disposed on the same substrate and receive reflected light from the reflective surface.

### SUMMARY OF THE INVENTION

One embodiment according to the technology of the present disclosure provides an operation ring and a lens device capable of detecting a rotation position with a high resolution in a case in which a rotation operation is performed, and a method of manufacturing an operation ring.

An aspect of the technology of the present disclosure provides an operation ring comprising: a ring member; a first recess portion; and plating, in which an inclined part is formed in the first recess portion. The first recess portion is formed in the ring member. The plating is applied to the first recess portion.

It is preferable that a plurality of the first recess portions are formed on an inner peripheral surface of the ring member, and the plating is applied to the plurality of first recess portions and a pattern serving as an indicator of a rotation operation is formed on the inner peripheral surface.

It is preferable that the first recess portion has a first surface part that is located radially outward with respect to an inner peripheral surface of the ring member, and a second recess portion that is recessed radially outward with respect to the first surface part is formed.

It is preferable that the second recess portion is a groove portion formed at an end part of the first surface part in a circumferential direction. It is preferable that the second recess portions are formed at both end parts of the first surface part in a circumferential direction.

It is preferable that the second recess portion includes a position at which a surface including the first surface part and the inclined part intersect with each other. It is preferable that the inclined part is inclined in an inner direction with respect to a radial direction at an inclination angle of 5° or more and 30° or less. It is preferable that the inclined part has a curved shape.

It is preferable that, in the first recess portion, a dimension of the first surface part is smaller than a dimension in a circumferential direction of the ring member, which is a dimension of an inlet portion in contact with the inner peripheral surface of the ring member.

It is preferable that a material of the operation ring is a carbon fiber composite material. It is preferable that, in the pattern, portions to which the plating is applied are disposed at an equal interval in a circumferential direction of the operation ring. It is preferable that the equal interval is an interval of 0.2 mm or more and 0.3 mm or less.

Another aspect of the technology of the present disclosure provides a lens device comprising: the operation ring described above; an optical system; and an electric zoom mechanism that drives a zoom lens group that is a part of the optical system, in accordance with rotation of the operation ring.

It is preferable that the optical system includes at least the zoom lens group, a first lens group, a filter, and a stop, the filter has a maximum outer diameter portion larger than a maximum outer diameter portion of the first lens group and is located on a subject side with respect to the first lens group, the zoom lens group is located between the first lens group and the stop and on the subject side with respect to the stop, and the pattern is located between the maximum outer diameter portion of the first lens group and the maximum outer diameter portion of the filter.

Still another aspect of the technology of the present disclosure provides an operation ring comprising: a ring member; a first recess portion; and plating, in which an inner peripheral surface of the ring member and the plating are located on the same surface. The first recess portion is formed in the ring member. The plating is applied to the first recess portion.

It is preferable that a plurality of the first recess portions are formed on the inner peripheral surface of the ring member, and the plating is applied to the plurality of first recess portions and a pattern serving as an indicator of a rotation operation is formed on the inner peripheral surface.

Still another aspect of the technology of the present disclosure provides a method of manufacturing an operation ring, the method comprising: a step of forming a first recess portion in a ring member; a step of forming an inclined part in the first recess portion; and a step of applying plating to the first recess portion.

### BRIEF DESCRIPTION OF THE DRAWINGS

FIG. 1 is an exploded perspective view of a digital camera.

FIG. 2 is a side view of the digital camera.

FIG. 3 is a main-part cross-sectional view of a lens barrel.

FIG. 4 is a perspective view of an electric zoom mechanism.

FIG. 5 is a main-part cross-sectional view of the lens barrel taken along a circumferential direction.

FIG. 6 is a circuit diagram showing an example of a sensor for detecting a rotation position and a rotation direction of an operation ring.

FIG. 7 is a perspective view of the operation ring and the sensor.

FIG. 8 is an enlarged perspective view of a part of a ring member.

FIG. 9 is a main-part cross-sectional view of the ring member taken along a periphery of a first recess portion.

FIG. 10 is an explanatory view showing an inclination angle of an inclined part of the first recess portion.

FIG. 11 is an enlarged perspective view of a part of the operation ring.

FIG. 12 is a main-part cross-sectional view showing a disposition of a pattern formed on the operation ring.

FIG. 13 is a block diagram showing a schematic configuration of the digital camera.

FIGS. 14A to 14E are explanatory views showing a method of manufacturing the operation ring.

FIG. 15 is a flowchart showing steps of manufacturing the operation ring.

FIG. 16 is a main-part cross-sectional view of an operation ring according to a second embodiment.

FIG. 17 is an enlarged perspective view of a part of a ring member according to the second embodiment.

FIG. 18 is a main-part cross-sectional view of the ring member according to the second embodiment taken along a periphery of a first recess portion.

FIG. 19 is a main-part cross-sectional view of an operation ring according to a third embodiment.

FIG. 20 is an explanatory view showing an inclination angle of an inclined part and a position of a second recess portion in the third embodiment.

FIG. 21 is a main-part cross-sectional view of an operation ring according to a fourth embodiment.

### DESCRIPTION OF THE PREFERRED EMBODIMENTS

### First Embodiment

### [Configuration of Digital Camera]

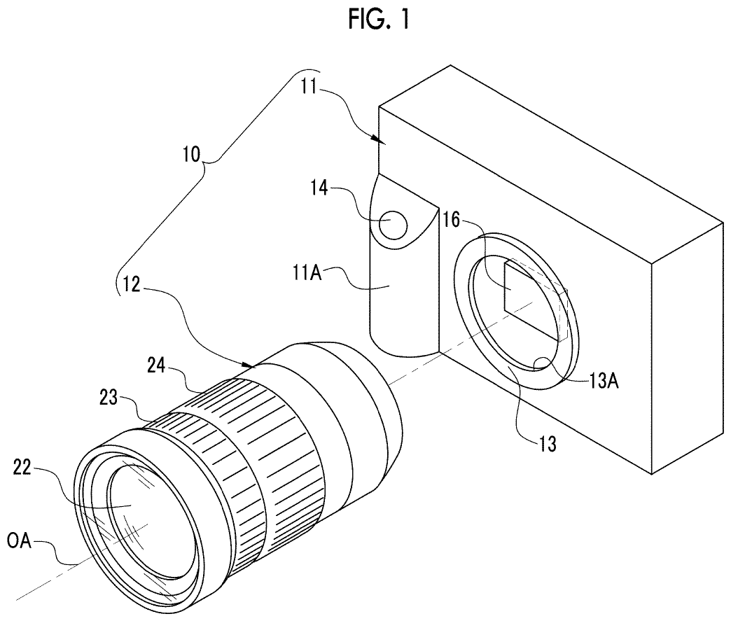

As shown in FIG. 1, a digital camera 10 comprises a camera body 11 and an interchangeable lens barrel 12. A front surface of the camera body 11 is provided with a lens mount 13, a release switch 14, a power switch (not shown), and the like. The lens mount 13 has a circular imaging aperture 13A. The lens barrel 12 is attachably and detachably mounted on the lens mount 13. The lens barrel 12 is an example of a lens device according to the embodiment of the present invention.

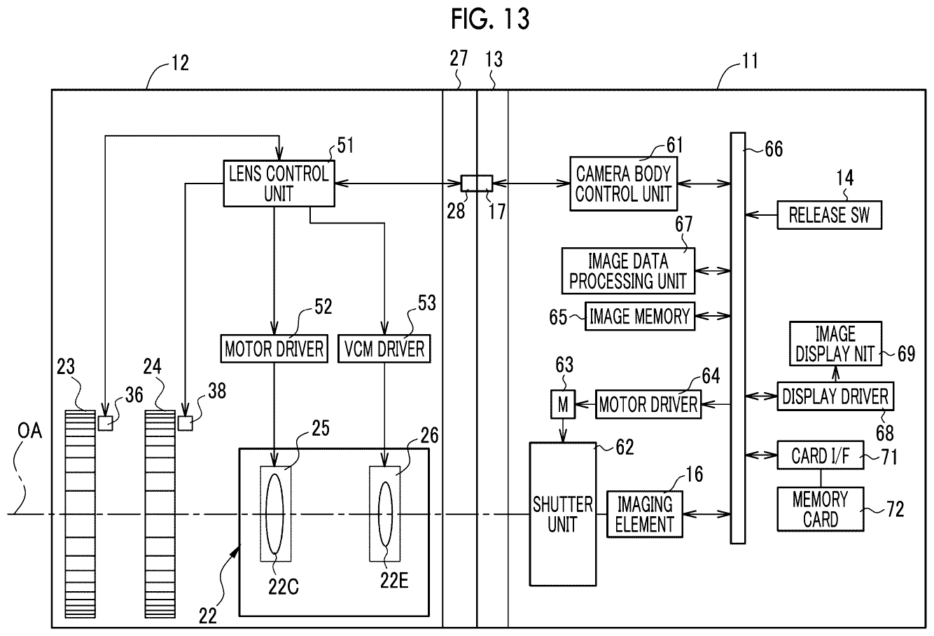

The camera body 11 has an imaging element 16 built therein. The imaging element 16 is a complementary metal-oxide-semiconductor (CMOS) image sensor, a charge-coupled device (CCD) image sensor, or an organic thin-film imaging element. The lens mount 13 is provided with a body-side signal contact 17 (see FIG. 13) inside the imaging aperture 13A for electrically connecting to and communicating with the lens barrel 12. The camera body 11 has a grip portion 11A.

### [Configuration of Lens Device]

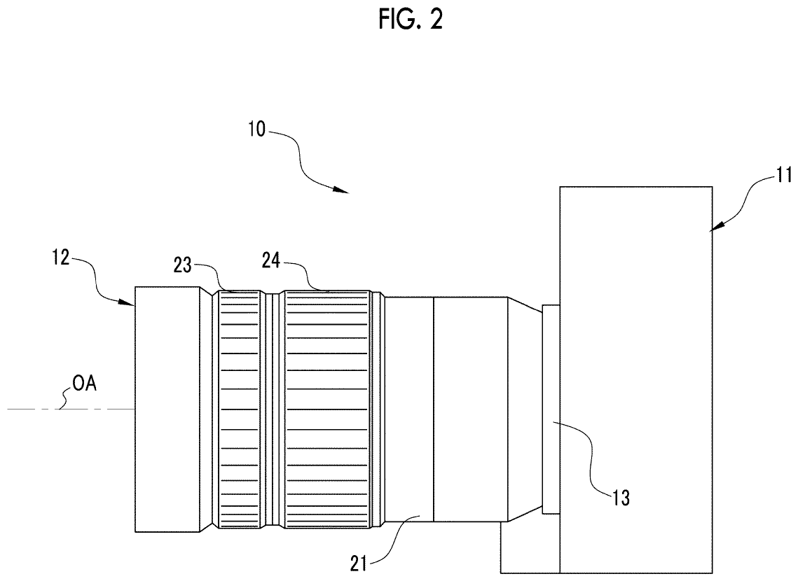

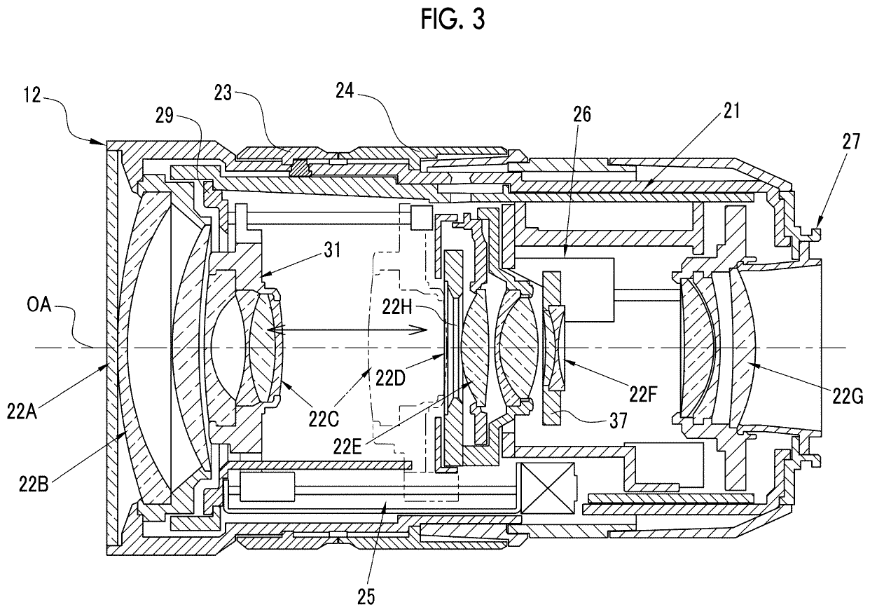

As shown in FIG. 2, the lens barrel 12 comprises a lens barrel body 21, an imaging optical system 22, a zoom ring 23, a focus ring 24, an electric zoom mechanism 25 (see FIG. 3), and a focus mechanism 26 (see FIG. 3). The zoom ring 23 corresponds to an operation ring in the claims.

The lens barrel body 21 has a cylindrical shape, holds the imaging optical system 22, the zoom ring 23, the focus ring 24, the electric zoom mechanism 25, and the focus mechanism 26 inside, and is provided with a lens mount 27 (see FIGS. 3 and 13) and a lens-side signal contact 28 (see FIG. 13) at a rear end thereof. The imaging optical system 22 forms an image of subject light on the imaging element 16 in a case in which the lens barrel 12 is mounted on the camera body 11.

The imaging optical system 22 comprises a filter 22A, a first lens group 22B, a second lens group 22C, a stop 22D, a third lens group 22E, a fourth lens group 22F, and a fifth lens group 22G which are disposed in this order from the subject side toward the imaging element side along an optical axis OA.

Among the first lens group 22B, the second lens group 22C, the third lens group 22E, the fourth lens group 22F, and the fifth lens group, the first lens group 22B has a largest outer diameter. The filter 22A is an optical filter such as a polarizing filter or a filter for light amount adjustment. The filter 22A has a maximum outer diameter portion larger than a maximum outer diameter portion of the first lens group 22B. The filter 22A and the first lens group 22B are fixed to a distal end part of the lens barrel body 21.

The second lens group 22C corresponds to a zoom lens in the claims. In the lens barrel 12, the second lens group 22C is moved along the optical axis OA to change magnification. The second lens group 22C is moved by using the electric zoom mechanism 25. The electric zoom mechanism 25 drives the second lens group 22C in accordance with the rotation of the zoom ring 23. The second lens group 22C is moved between a wide angle side position (position indicated by a solid line in FIG. 3) and a telephoto side position (position indicated by a two-dot chain line).

The stop 22D is a fixed stop in which an open F number is fixed, and a stop aperture 22H is formed at the center of a thin plate member. The stop 22D is fixed to the inside of the lens barrel body 21. It should be noted that the stop 22D is not limited to this, and may be a variable stop composed of a stop mechanism that varies the open F number. The third lens group 22E is a relay lens group fixed to the inside of the lens barrel body 21.

The fourth lens group 22F is a focus lens. In the lens barrel 12, the focus is adjusted by moving the fourth lens group 22F in a direction of the optical axis OA. The fourth lens group 22F is moved by using the focus mechanism 26. The focus mechanism 26 drives the fourth lens group 22F in accordance with the rotation of the focus ring 24. The fifth lens group 22G is a relay lens group fixed to the rear end part of the lens barrel body 21. The fifth lens group 22G forms an image of a real image transmitted through the filter 22A, the first lens group 22B, the second lens group 22C, the stop 22D, the third lens group 22E, and the fourth lens group 22F, on the imaging element.

The electric zoom mechanism 25 is disposed inside the lens barrel 12. The electric zoom mechanism 25 drives the second lens group 22C that is a part of the imaging optical system 22. The electric zoom mechanism 25 is attached to the lens barrel body 21 via an attachment member 29 and the like. As described above, the second lens group 22C is located between the first lens group 22B and the stop 22D and is located on a subject side with respect to the stop 22D. That is, the second lens group 22C can move between the first lens group 22B and the stop 22D.

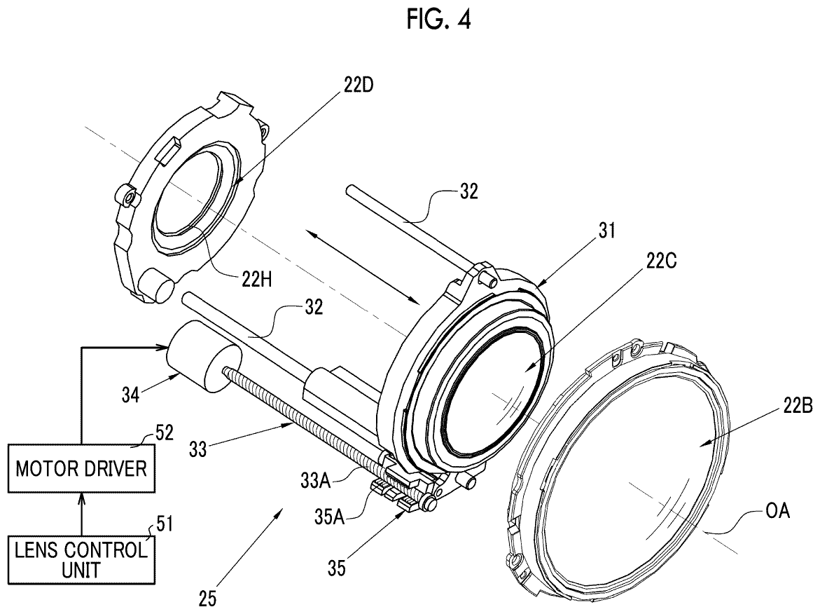

As shown in FIG. 4, the second lens group 22C is held by a lens holding frame 31. The lens holding frame 31 is connected to a zoom carriage 35 described later. The electric zoom mechanism 25 comprises two guide shafts 32, a lead screw 33, a motor 34, and the zoom carriage 35. A lens control unit 51 controls the energization of the motor 34 via a motor driver 52. As will be described later, the lens control unit 51 controls the respective units of the lens barrel 12.

The guide shaft 32 is a cylindrical shaft made of metal or resin. A distal end and a base end of the guide shaft 32 are directly attached to the lens barrel body 21, or are attached to the lens barrel body 21 via the attachment member 29. The lens holding frame 31 is attached to the guide shaft 32 to be movable in the direction of the optical axis OA.

The lead screw 33 is a substantially cylindrical axis made of metal or resin and having a screw 33A on an outer periphery thereof. The lead screw 33 is connected to a rotation shaft of the motor 34 and is rotationally moved in both directions by using the motor 34. The motor 34 is, for example, a stepping motor.

The zoom carriage 35 is connected to the lens holding frame 31 and moves along the guide shaft 32, that is, in the direction of the optical axis OA along with the second lens group 22C and the lens holding frame 31. A rack gear 35A is formed on a surface of the zoom carriage 35 facing the lead screw 33. The zoom carriage 35 is biased to a screw 33A of the lead screw 33 by using a spring member (not shown). The rack gear 35A meshes with the screw 33A. Therefore, the rotation of the lead screw 33 is converted into a linear movement by the screw 33A and the rack gear 35A, and the second lens group 22C is moved along the direction of the optical axis OA along with the lens holding frame 31.

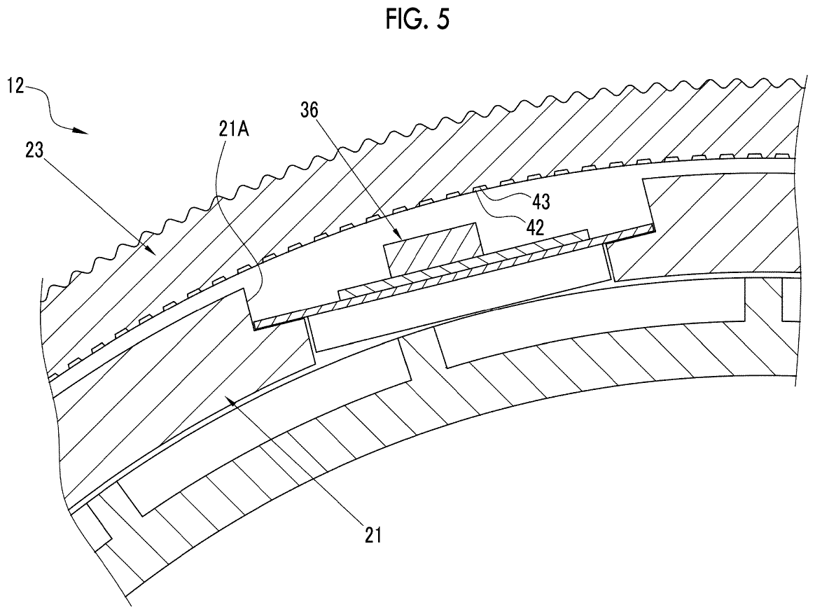

The lens control unit 51 detects a rotation position of the zoom ring 23 via a sensor 36 (see FIGS. 5 to 7 and 13), and moves the second lens group 22C in accordance with information on a rotation direction and the rotation position. The sensor 36 is a sensor capable of performing detection with a high resolution, and for example, a photoreflector is used.

The focus mechanism 26 is composed of a voice coil motor (hereinafter, referred to as a VCM), and comprises a magnetic circuit and a coil (which are not shown). The fourth lens group 22F is held by a lens holding frame 37. The magnetic circuit or the coil is connected to the lens holding frame 37. In the focus mechanism 26, the lens holding frame 37 and the fourth lens group 22F are driven by using a magnetic force generated by energizing the coil.

The lens control unit 51 detects a rotation position of the focus ring 24 via a sensor 38 (see FIG. 13), and moves the fourth lens group 22F in accordance with information on a rotation direction and a rotation amount. It should be noted that the configuration of the focus mechanism 26 is not limited to this, and the focus mechanism 26 may comprise a lead screw, a motor, and the like as in a case of the electric zoom mechanism 25, and may convert the rotation of the lead screw into a linear movement to move the fourth lens group 22F in the direction of the optical axis OA.

### [Configuration of Sensor]

As shown in FIG. 5, the sensor 36 is attached to an opening portion 21A formed in the lens barrel body 21. The sensor 36 is disposed at a position facing an inner peripheral surface of the zoom ring 23. A pattern 44, which will be described later, is formed on the inner peripheral surface of the zoom ring 23, a signal based on the pattern 44 is obtained by the sensor 36, and thus the rotation direction and the rotation position of the zoom ring 23 can be detected.

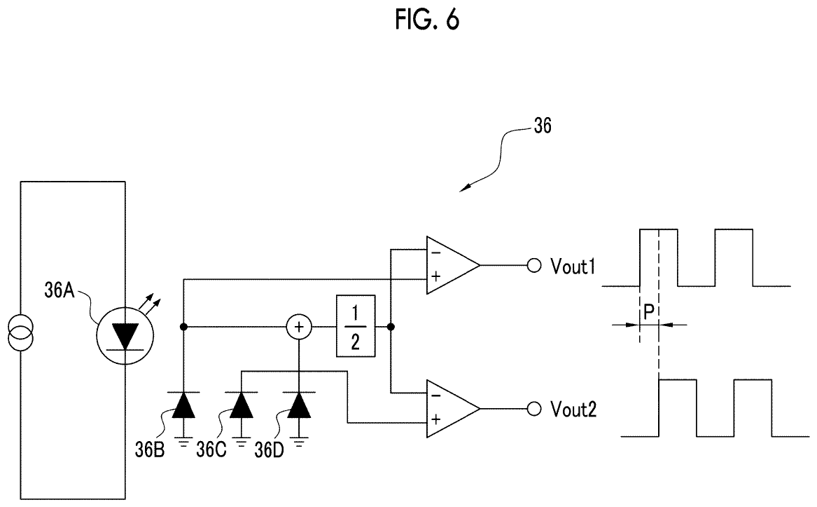

FIG. 6 shows an example of a circuit constituting the sensor 36. In the example shown in FIG. 5, the sensor 36 comprises a light-emitting diode (LED) 36A and three light-receiving integrated circuits (ICs) 36B, 36C, and 36D on a substrate. The sensor 36 is disposed such that a phase difference between output signals is generated by 90° in an order of the light-receiving ICs 36B, 36C, and 36D.

By emitting light and receiving light with respect to a pattern having a low reflective portion and a high reflective portion using the sensor 36 having the above-described configuration, it is possible to output digital two-phase signals Vout1 and Vout2 in which a phase P is deviated by 90°. The rotation direction and the rotation position can be detected by using these two-phase signals Vout1 and Vout2. Further, by detecting the rising/falling of the two-phase signals Vout1 and Vout2 of the sensor 36, a resolution of ¼ of a pattern period is obtained.

### [Configuration of Operation Ring]

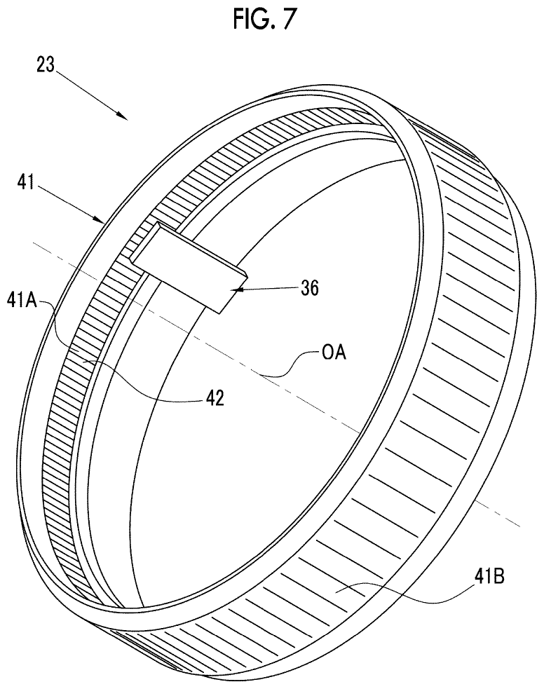

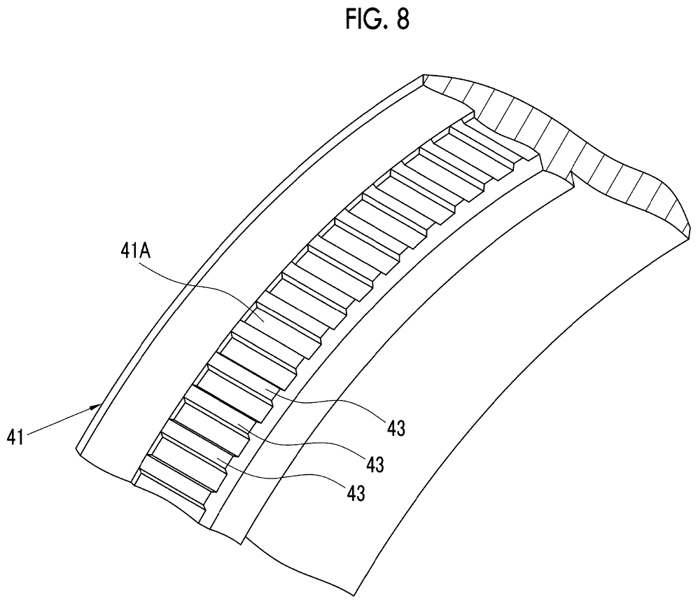

As shown in FIG. 7, the zoom ring 23 comprises a ring member 41 and plating 42. As shown in FIG. 8, a first recess portion 43 is formed in the ring member 41. The first recess portion 43 is, for example, a recess portion formed by irradiating an inner peripheral surface 41A of the ring member 41 with a laser. It is preferable that the first recess portion 43 has a linear shape parallel to the optical axis OA.

The first recess portion 43 is a recess portion that is recessed radially outward with respect to the inner peripheral surface 41A of the ring member 41. It should be noted that the radial direction described herein is the radial direction of the ring member 41 and is a direction orthogonal to the optical axis OA in a case in which the zoom ring 23 is incorporated in the lens barrel body 21, and the same applies hereinafter.

The plating 42 is applied to the first recess portion 43. The plating 42 is formed by metalizing an electroless plating catalyst through an electroless plating treatment. A material of the plating 42 need only be a metal material obtained by metalizing the electroless plating catalyst, and is, for example, palladium or nickel. A material of the ring member 41 is a carbon fiber composite material. The ring member 41 is formed in an annular shape, and a knurl is formed on an outer peripheral surface 41B. The ring member 41 is externally fitted onto the lens barrel body 21. A plurality of first recess portions 43 are formed on the inner peripheral surface 41A of the ring member 41.

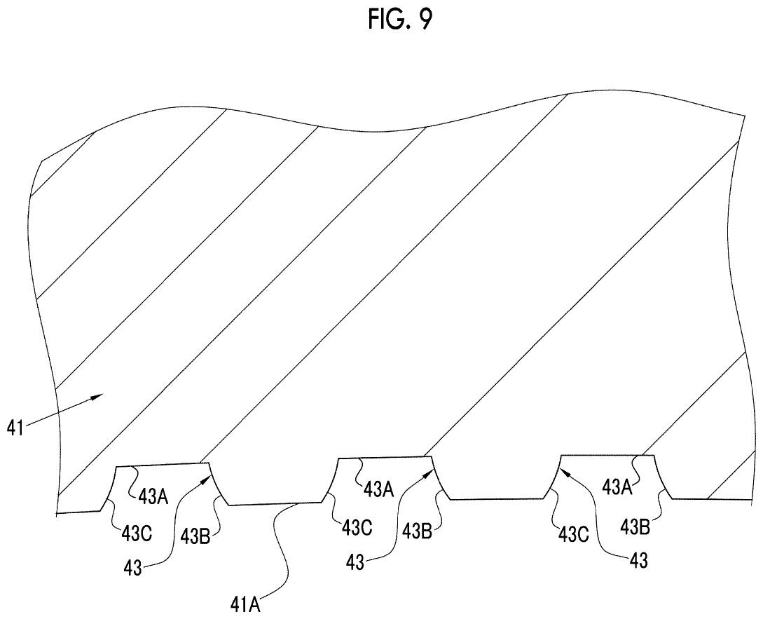

As shown in FIG. 9, the first recess portion 43 has a first surface part 43A and inclined parts 43B and 43C. The first surface part 43A is located radially outward with respect to the inner peripheral surface 41A of the ring member 41. It should be noted that FIGS. 8 to 10 show a state before the plating 42 is applied to the ring member 41.

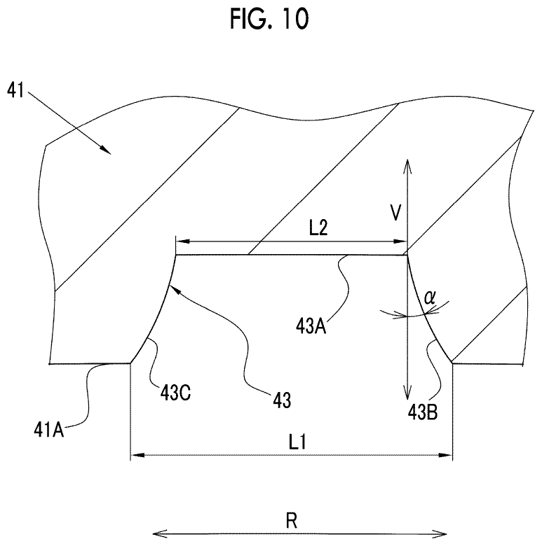

As shown in FIG. 10, the inclined part 43B is inclined with respect to a radial direction V of the ring member 41. Specifically, the inclined part 43B is inclined in an inner direction with respect to the radial direction V at an inclination angle α of 5° or more and 30° or less. It should be noted that the inner direction described here means a direction in which the inclined part 43B is inclined toward an inner side of the ring member 41.

The inclined part 43C is also inclined in the inner direction with respect to the radial direction V at the inclination angle α of 5° or more and 30° or less, as in the inclined part 43B. In addition, the inclined parts 43B and 43C have a curved shape. Specifically, the inclined parts 43B and 43C have a curved shape that protrudes toward the inner side of the ring member 41.

In an operation ring in the related art, in a case in which a recess portion is formed in a ring member and plating is applied, a side surface of the recess portion is formed at a right angle with respect to a surface of the ring member. That is, since there is a right angle corner at which the surface of the ring member and a side surface of the recess portion intersect with each other, a plating catalyst or a reducing agent forming the plating may be blocked by the right angle corner, and may be difficult to enter the recess portion. It should be noted that the range of the inclination angle α described in the present specification is a preferable range, and a certain effect is exhibited even in a case of being out of the range.

On the other hand, in the zoom ring 23 according to the present embodiment, since the first recess portion 43 has the inclined parts 43B and 43C, in a case in which the plating 42 is applied to the ring member 41, the plating catalyst and the reducing agent that form the plating 42 are likely to enter the first recess portion 43. Since the inclined parts 43B and 43C are formed in a curved shape, the plating catalyst and the reducing agent that form the plating 42 are more likely to enter the first recess portion 43.

In addition, in the first recess portion 43, a dimension L2 of the first surface part 43A is smaller than a dimension L1 in a circumferential direction R of the ring member 41, which is a dimension of an inlet portion in contact with the inner peripheral surface 41A of the ring member 41. That is, the first recess portion 43 is a trapezoidal recess portion in which a dimension in the circumferential direction R gradually decreases toward the outer side in the radial direction V. Therefore, the plating catalyst and the reducing agent that form the plating 42 are more likely to enter the first recess portion 43.

In the zoom ring 23, the plurality of first recess portions 43 are formed on the inner peripheral surface 41A of the ring member 41, and the plating 42 is applied to form the pattern 44, which is an indicator of the rotation operation, on the inner peripheral surface 41A. The plating 42 applied to the first recess portion 43 serves as the high reflective portion that reflects light because the material of the plating 42 is a metal material. As described above, since the ring member 41 is made of the carbon fiber composite material, the ring member 41 is a low reflective portion that reflects less light than in the plating 42. That is, the pattern 44 is formed in which the plating 42 serving as the high reflective portion and a portion between pieces of the plating 42 as the low reflective portion are alternately arranged. As described above, it is possible to detect the rotation direction and the rotation amount of the zoom ring 23 by combining the pattern 44 and the sensor 36.

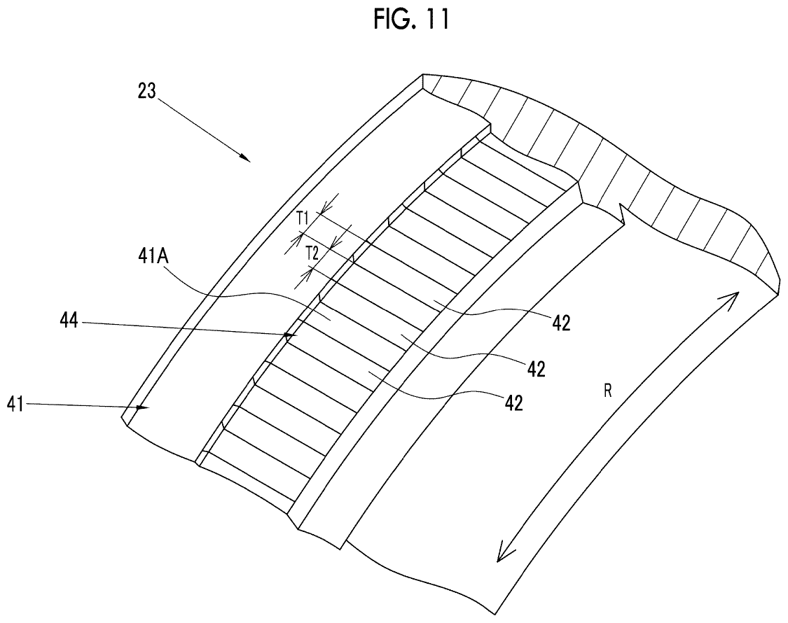

As shown in FIG. 11, in the pattern 44, the portions to which the plating 42 is applied are disposed at an equal interval in the circumferential direction R of the zoom ring 23. That is, a width T1 of the plating 42 in the circumferential direction R and a width T2 of the portion between pieces of the plating 42 have a constant dimension. It should be noted that it is preferable that the widths T1 and T2 are set to an interval of 0.2 mm or more and 0.3 mm or less. In this way, the rotation position of the zoom ring 23 can be detected with a high resolution by forming the fine pattern 44.

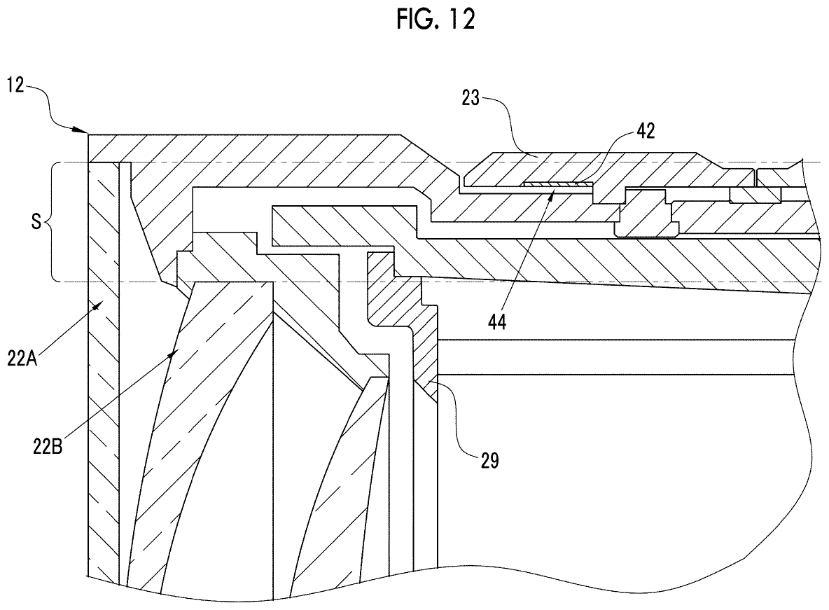

As shown in FIG. 12, the pattern 44 is located between the maximum outer diameter portion of the first lens group 22B and the maximum outer diameter portion of the filter 22A. The reference numeral S denotes a space between the maximum outer diameter portion of the first lens group 22B and the maximum outer diameter portion of the filter 22A, and the pattern 44 is disposed in the space S. As described above, the second lens group 22C and the electric zoom mechanism 25 that drives the second lens group 22C are disposed on the base end side (imaging element side) of the first lens group 22B, and thus a space for disposing the components is small. Therefore, the pattern 44 is disposed at a position at which the pattern 44 does not interfere with the second lens group 22C, the electric zoom mechanism 25, and the like, and thus the efficiency of component disposition is improved. The filter 22A has the maximum outer diameter portion larger than the maximum outer diameter portion of the first lens group 22B, and is located on the subject side with respect to the first lens group 22B. That is, the space S has a relatively sufficient space for component disposition in the lens barrel 12. By disposing the pattern 44 in such a space S, the efficiency of component disposition is improved, and the size reduction of the lens barrel 12, particularly the reduction of the outer diameter thereof, can be achieved.

### [Electric Configuration of Digital Camera]

As shown in FIG. 13, the lens barrel 12 comprises the imaging optical system 22, the zoom ring 23, the focus ring 24, the electric zoom mechanism 25, the focus mechanism 26, the sensor 36, the sensor 38, the lens control unit 51, the motor driver 52, a VCM driver 53, and the like.

The lens control unit 51 consists of a microcomputer comprising a central processing unit (CPU), a read-only memory (ROM) that stores programs or parameters used in the CPU, a random access memory (RAM) used as a work memory of the CPU (none of which is shown), and controls the respective units of the lens barrel 12. The motor driver 52, the VCM driver 53, the sensor 36, and the sensor 38 are connected to the lens control unit 51.

The lens control unit 51 controls the drive of the second lens group 22C based on a control signal from the camera body control unit 61, which will be described later. The lens control unit 51 detects the rotation position of the zoom ring 23 via the sensor 36, and moves the second lens group 22C in accordance with the information on the rotation direction and the rotation amount.

As described above, although the imaging optical system 22 comprises a plurality of lens groups including the second lens group 22C and the fourth lens group 22F, in FIG. 13, in order to prevent the drawings from becoming complicated, the lens groups other than the second lens group 22C and the fourth lens group 22F are omitted. The second lens group 22C is moved in the direction of the optical axis OA by energizing the motor 34 constituting the electric zoom mechanism 25 from the motor driver 52, and varies an angle of view of the imaging optical system 22. The lens control unit 51 transmits the control signal for moving the second lens group 22C to the motor driver 52 in accordance with the information on the rotation direction and the rotation amount of the zoom ring 23. The motor driver 52 energizes the motor 34 based on the control signal.

The fourth lens group 22F is moved in the direction of the optical axis OA by energizing the coil constituting the focus mechanism 26 from the VCM driver 53, and adjusts the focus of the imaging optical system 22. The lens control unit 51 transmits the control signal for moving the fourth lens group 22F to the VCM driver 53 in accordance with the information on the rotation direction and the rotation amount of the focus ring 24. The VCM driver 53 energizes the coil based on the control signal.

The camera body control unit 61 comprises a CPU, a ROM that stores programs or parameters used in the CPU, and a RAM used as a work memory of the CPU (none of which is shown). The camera body control unit 61 controls the camera body 11 and the respective units of the lens barrel 12 connected to the camera body 11. A release signal is input to the camera body control unit 61 from the release switch 14. The body-side signal contact 17 is connected to the camera body control unit 61.

The lens-side signal contact 28 is in contact with the body-side signal contact 17 in a case in which the lens mount 27 of the lens barrel 12 is mounted on the lens mount 13 of the camera body 11, and the lens barrel 12 and the camera body 11 are electrically connected to each other.

A shutter unit 62 is a so-called focal plane shutter, and is disposed between the lens mount 13 and the imaging element 16. The shutter unit 62 is provided to be capable of blocking an optical path between the imaging optical system 22 and the imaging element 16, and is changed between an open state and a closed state. The shutter unit 62 is put into the open state in a case of capturing a live view image and a moving image. In a case of capturing a still image, the shutter unit 62 is temporarily put into the closed state from the open state. The shutter unit 62 is driven by a shutter motor 63. A motor driver 64 controls the driving of the shutter motor 63.

The imaging element 16 is driven and controlled by the camera body control unit 61. The imaging element 16 has a light-receiving surface composed of a plurality of pixels (not shown) arranged in a two-dimensional matrix. Each pixel includes a photoelectric conversion element, and performs photoelectric conversion of a subject image formed on the light-receiving surface via the imaging optical system 22 to generate an imaging signal.

The imaging element 16 comprises a signal processing circuit (none of which is shown), such as a noise removal circuit, an auto gain controller, and an A/D conversion circuit. The noise removal circuit performs noise removal processing on the imaging signal. The auto gain controller amplifies a level of the imaging signal to an optimal value. The A/D conversion circuit converts the imaging signal into a digital signal and outputs the converted signal from the imaging element 16 to a busline 66. The output signal of the imaging element 16 is image data (so-called RAW data) having one color signal for each pixel.

An image memory 65 stores image data for one frame output to the busline 66. An image data processing unit 67 reads out the image data for one frame from the image memory 65 and performs known image processing, such as matrix operation, demosaicing processing, Y correction, brightness/color difference conversion, and resizing processing.

The display driver 68 sequentially inputs the image data for one frame, which is image-processed by the image data processing unit 67, to the image display unit 69. The image display unit 69 is provided, for example, on a rear surface of the camera body 11 and sequentially displays the live view images at regular intervals. A card interface (I/F) 71 is incorporated in a card slot (not shown) provided in the camera body 11 and is electrically connected to a memory card 72 inserted in the card slot. The card I/F 71 stores the image data subjected to the image processing by the image data processing unit 67 in the memory card 72. In a case in which the image data stored in the memory card 72 is reproduced and displayed, the card I/F 71 reads out the image data from the memory card 72.

### [Step of Manufacturing Operation Ring]

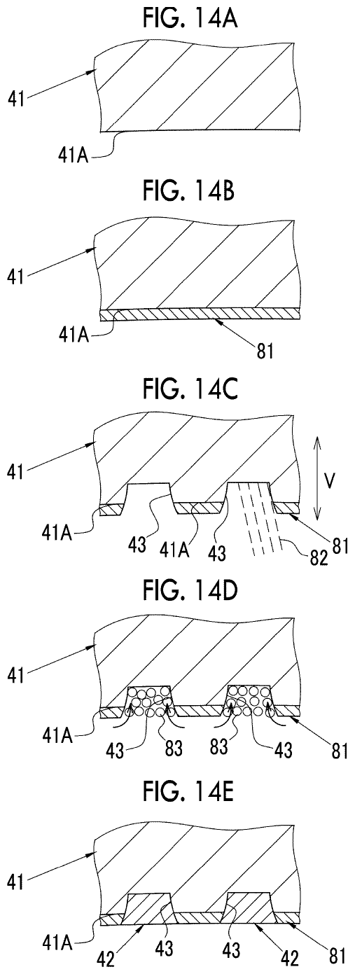

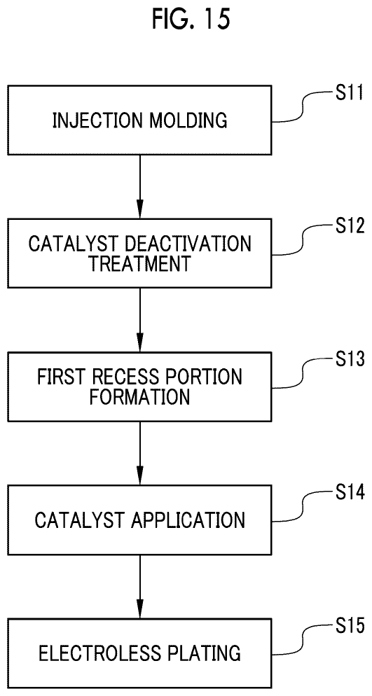

Hereinafter, a step of manufacturing the zoom ring 23 will be described with reference to the explanatory views shown in FIGS. 14A to 14E and the flowchart shown in FIG. 15. The zoom ring 23 is manufactured by a molded interconnected device (MID) process. As shown in FIG. 14A, first, the ring member 41 is formed by an injection molding step and the like (S11). Before the pattern 44 is formed, the first recess portion 43 is not yet formed in a state in which the ring member 41 is made of the carbon fiber composite material by the injection molding step or the like. It should be noted that, in FIGS. 14B to 14E, for convenience of description, a thin film 81 and an electroless plating catalyst 83 are drawn large, but are actually much smaller than those shown in the drawings.

As shown in FIG. 14B, a step of performing a catalyst deactivation treatment on the surface of the ring member 41 is performed as a step before the first recess portion 43 is formed (S12). Specifically, the thin film 81 is formed on the surface of the ring member 41 with a polymer that is a catalyst deactivation material. The thin film 81 inhibits the activation of the electroless plating catalyst which will be described later. A thickness of the thin film 81 is, for example, less than 1 nm. It should be noted that, in FIG. 14B, the thin film 81 is formed only on the inner peripheral surface 41A for convenience of illustration, but in practice, the thin film 81 is formed on the entire surface of the ring member 41.

The method of forming the thin film 81 on the surface of the ring member 41 is not particularly limited. For example, a polymer solution may be prepared in which the polymer as the catalyst deactivation material is dissolved or dispersed in a solvent, and the polymer solution may be brought into contact with the ring member 41 to form the thin film 81. As the method of bringing the polymer solution into contact with the ring member 41, the polymer solution may be applied to the ring member 41, or the ring member 41 may be immersed in the polymer solution.

After the thin film 81 is formed, as shown in FIG. 14C, a step of removing a part of the thin film 81 via the laser irradiation and further forming the first recess portion 43 is performed (S13). As a result, the electroless plating catalyst can be activated in a portion from which the thin film 81 has been removed, that is, the first recess portion 43.

In addition, in the present embodiment, a step of forming the inclined parts 43B and 43C is also performed in a step (S3) of forming the first recess portion. For example, as shown in FIG. 14C, the inclined parts 43B and 43C are formed by irradiation with a laser 82 along a direction inclined with respect to the radial direction V.

After removing a part of the thin film 81 and forming the first recess portion 43, a step of immersing the ring member 41 in an electroless plating catalyst solution containing an ionic metal compound, to apply the electroless plating catalyst 83 is performed (S14). By immersing the first member in the electroless plating catalyst solution, the electroless plating catalyst 83 enters the first recess portion 43 as shown in FIG. 14D. That is, the electroless plating catalyst 83 is applied to the first recess portion 43 of the ring member 41. On the other hand, in the ring member 41, a portion other than the first recess portion 43, that is, a portion in which the thin film 81 remains, is not given the electroless plating catalyst 83 because the catalyst deactivation material inhibits the activation of the electroless plating catalyst.

Then, after the electroless plating catalyst 83 is applied, a treatment of immersing the ring member 41 in the electroless plating catalyst solution containing the reducing agent, that is, a step of applying the electroless plating is performed (S15). As a result, as shown in FIG. 14E, in the first recess portion 43, the electroless plating catalyst 83 is metalized by using the reducing agent, and the plating 42 is applied.

### [Operation of Lens Device]

The operation of the lens barrel 12 according to the present embodiment will be described. In a case in which the lens barrel 12 is mounted on the camera body 11 and the power switch (not shown) is operated by a user as a person who captures an image, the power is supplied to each unit of the digital camera 10.

In a state in which the power of the digital camera 10 is turned on, the imaging element 16, the camera body control unit 61, the lens control unit 51, and the like are activated. As described above, the rotation position of the zoom ring 23 is detected by the sensor 36, and the lens control unit 51 moves the second lens group 22C in accordance with the information on the rotation direction and the rotation position.

As described above, in the zoom ring 23, since the first recess portion 43 formed in the ring member 41 has the inclined parts 43B and 43C, the electroless plating catalyst and the reducing agent are likely to enter the first recess portion 43. As a result, the accuracy of the plating 42 with respect to the first recess portion 43 can be improved, and the pattern 44 having a fine high reflective portion and a fine low reflective portion can be formed. Therefore, in a case in which the zoom ring 23 is rotated, the sensor 36 can detect the rotation position of the zoom ring 23 with a high resolution.

For example, in a case in which the width of the plating 42 constituting the pattern 44 is 0.25 mm, the interval between pieces of the plating 42 is 0.25 mm, that is, the pattern period is 0.5 mm, the sensor 36 emits light and receives light with respect to the pattern to obtain the two-phase signals Vout1 and Vout2, and the rotation direction and the rotation position can be detected by the two-phase signals Vout1 and Vout2. Further, as described above, by detecting the rising/falling of the two-phase signals Vout1 and Vout2 of the sensor 36, it is possible to detect a change in the rotation position corresponding to a resolution of ¼ of the pattern period, that is, 0.125 mm.

Since the pattern 44 formed on the zoom ring 23 is formed of the plating 42 having a very small thickness, the thickness and the outer diameter of the zoom ring 23 can be reduced. Therefore, it is possible to achieve the size reduction of the lens barrel 12 and reduction of the outer diameter thereof.

By forming the pattern 44 with the plating 42, it is not necessary to provide the pattern with a component different from the zoom ring 23, and it is possible to facilitate the assembly step, reduce the number of components, and reduce costs. In addition, although it is necessary to apply a lubricant such as grease to the inner peripheral surface in order to smoothly rotate the zoom ring 23 in the lens barrel 12, since the plating 42 has resistance to the lubricant, it is possible to easily perform a lubricant applying step, and it is not necessary to perform a step of wiping off an excess lubricant. Therefore, it is possible to further achieve the cost reduction of the lens barrel 12.

### Second Embodiment

In the first embodiment, the accuracy of the plating 42 is improved by the first recess portion 43 having the inclined parts 43B and 43C, but the present invention is not limited to this, and in a second embodiment described later, a configuration will be described in which a second recess portion that is recessed radially outward with respect to the first surface part of the first recess portion is provided.

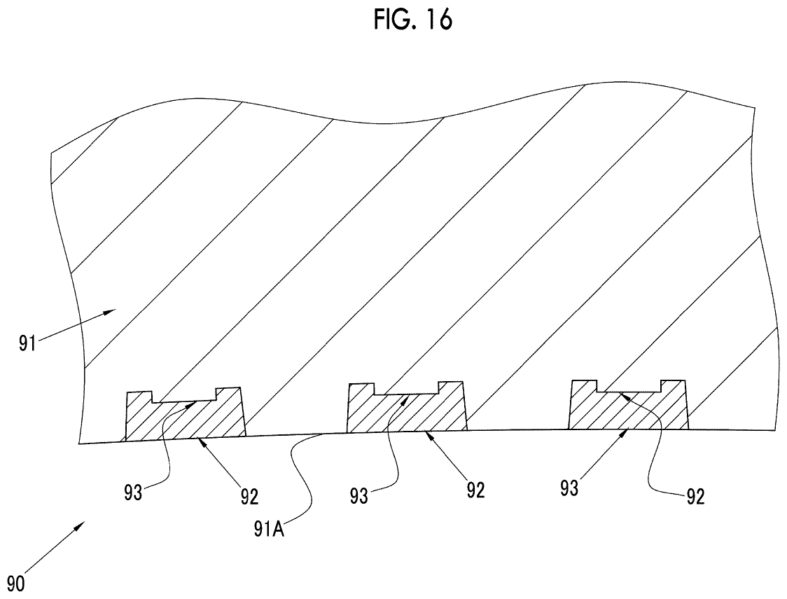

As shown in FIG. 16, the zoom ring 90 according to the present embodiment comprises a ring member 91 and plating 92. The zoom ring 90 corresponds to an operation ring in the claims. It should be noted that the configuration of the lens device, such as the imaging optical system 22 and the electric zoom mechanism 25, except for the zoom ring 90, is the same as the configuration in the above-described embodiment, and the description thereof will be omitted. In addition, by applying the plating 92 to the ring member 91, the pattern formed on an inner peripheral surface 91A is a pattern that serves as an indicator of the rotation operation, as in the pattern 44 according to the first embodiment, and the portions to which the plating 92 is applied are disposed at an equal interval in the circumferential direction R of the zoom ring 90.

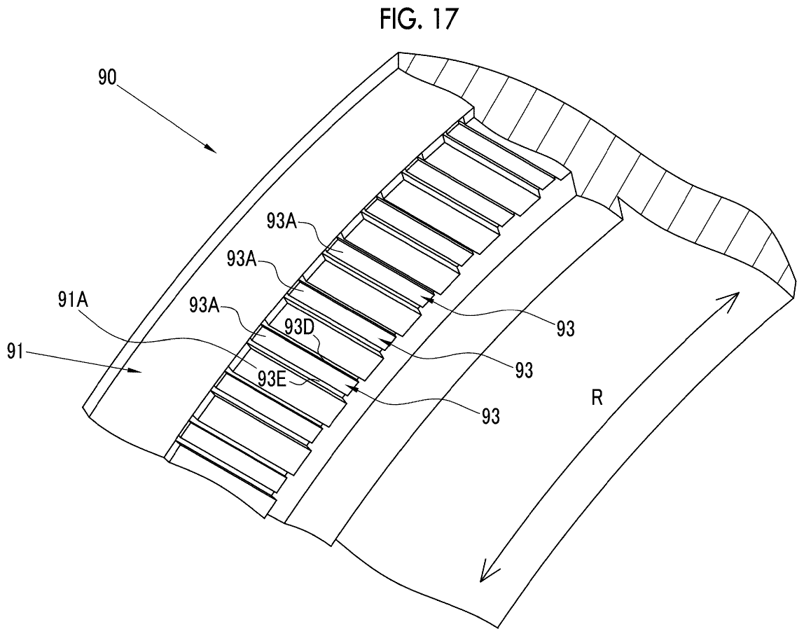

As shown in FIG. 17, a first recess portion 93 is formed in the ring member 91. The first recess portion 93 is a recess portion that is recessed radially outward with respect to the inner peripheral surface 91A of the ring member 91. It is preferable that the first recess portion 93 has a linear shape parallel to the optical axis OA.

The plating 92 is applied to the first recess portion 93. The plating 92 is formed by metalizing the electroless plating catalyst through an electroless plating treatment, similarly to the plating 42 according to the first embodiment. A material of the ring member 91 is a carbon fiber composite material. The ring member 91 is externally fitted onto the lens barrel body 21. A plurality of first recess portions 93 are formed on the inner peripheral surface 91A of the ring member 91.

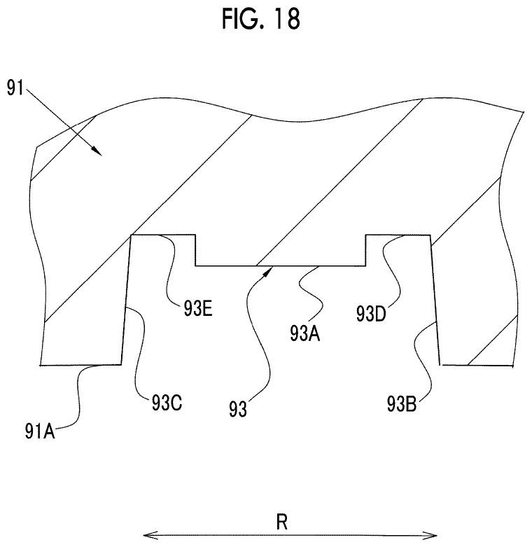

As shown in FIG. 18, the first recess portion 93 has a first surface part 93A and side surfaces 93B and 93C. The first surface part 93A is located radially outward with respect to the inner peripheral surface 91A of the ring member 91. The side surfaces 93B and 93C are surfaces located between the first surface part 93A and the inner peripheral surface 91A. It should be noted that FIGS. 17 and 18 show a state before the plating 92 is applied to the ring member 91.

Second recess portions 93D and 93E formed in the first recess portion 93. The second recess portions 93D and 93E are recess portions that are recessed radially outward with respect to the first surface part 93A. The second recess portions 93D and 93E are formed at both end parts of the first surface part 93A in the circumferential direction R. It should be noted that the present invention is not limited to this, and only one of the second recess portion 93D or the second recess portion 93E may be formed at the end part of the first surface part 93A in the circumferential direction R. In the examples shown in FIGS. 17 and 18, the second recess portions 93D and 93E are groove portions having a rectangular cross section, but may be groove portions having a V-shaped or U-shaped cross section.

A step of manufacturing the zoom ring 90 is the same as the step of manufacturing the zoom ring 23 according to the first embodiment, and the zoom ring 90 is manufactured by the MID process. That is, the plating 92 is formed in the first recess portion 93 of the ring member 91 by performing each of the steps of injection molding, catalyst deactivation treatment, removal of a part of the thin film, the first recess portion formation, the catalyst application, and electroless plating. It should be noted that, in this case, in a step of forming the first recess portion 93, a step of forming the second recess portions 93D and 93E is also performed. For example, the second recess portions 93D and 93E are formed by reducing the laser irradiation width than in case of forming the first recess portion 93.

As described above, in the zoom ring 90, the first recess portion 93 and the second recess portions 93D and 93E that are recessed radially outward with respect to the first surface part 93A of the first recess portion 93 are formed. As a result, in a step of forming the plating 92, the electroless plating catalyst and the reducing agent enter the first recess portion 93 and the second recess portions 93D and 93E, so that surface tension is unlikely to be generated. That is, the electroless plating catalyst and the reducing agent are less likely to bulge on the inner peripheral surface 91A, and thus the plating 92 can be formed to be thin. Therefore, as in the first embodiment, the accuracy of the plating 92 with respect to the first recess portion 93 can be improved, and the pattern having a fine high reflective portion and a fine low reflective portion can be formed. Therefore, in a case in which the zoom ring 90 is rotated, the sensor 36 can detect the rotation position of the zoom ring 90 with a high resolution.

In addition, by forming the pattern formed on the zoom ring 90 with the plating 92, the same effects as in the first embodiment, such as the size reduction of the lens barrel 12, the cost reduction, ease of steps, and reduction in the number of steps, can be obtained.

### Third Embodiment

Although the first recess portion 43 has the inclined parts 43B and 43C in the first embodiment, and the second recess portions 93D and 93E are formed in the first recess portion 93 in the second embodiment, in the third embodiment described later, both the inclined part and the second recess portion are formed in the first recess portion.

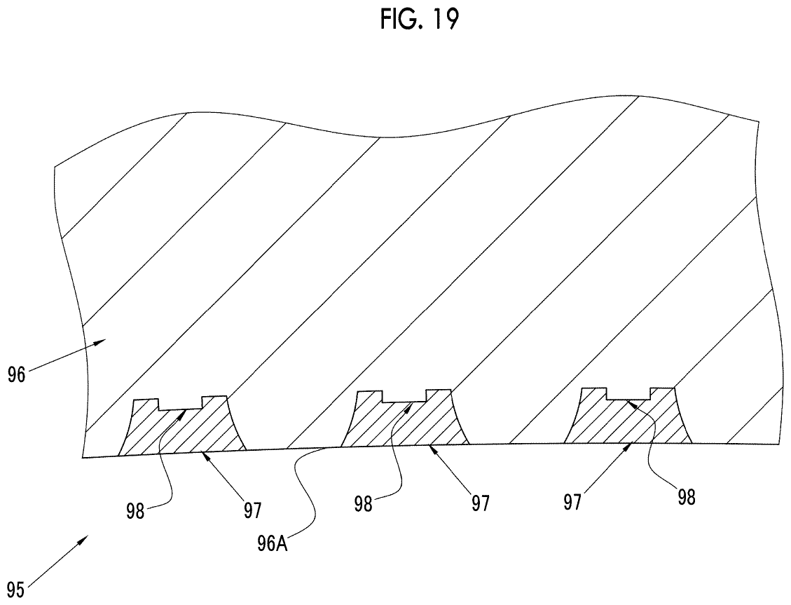

As shown in FIG. 19, the zoom ring 95 according to the present embodiment comprises a ring member 96 and plating 97. The zoom ring 95 corresponds to an operation ring in the claims. It should be noted that the configuration of the lens device, such as the imaging optical system 22 and the electric zoom mechanism 25, except for the zoom ring 95, is the same as the configuration in the above-described embodiment, and the description thereof will be omitted. In addition, by applying the plating 97 to the ring member 96, the pattern formed on an inner peripheral surface 96A is a pattern that serves as an indicator of the rotation operation, as in the pattern 44 according to the first embodiment, and the portions to which the plating 97 is applied are disposed at an equal interval in the circumferential direction R of the zoom ring 95.

A first recess portion 98 is formed in the ring member 96. The first recess portion 98 is a recess portion that is recessed radially outward with respect to the inner peripheral surface 96A of the ring member 96. It is preferable that the first recess portion 98 has a linear shape parallel to the optical axis OA.

The plating 97 is applied to the first recess portion 98. The plating 97 is formed by metalizing the electroless plating catalyst through an electroless plating treatment, similarly to the plating 42 according to the first embodiment. A material of the ring member 96 is a carbon fiber composite material. The ring member 96 is externally fitted onto the lens barrel body 21. A plurality of first recess portions 98 are formed on the inner peripheral surface 96A of the ring member 96.

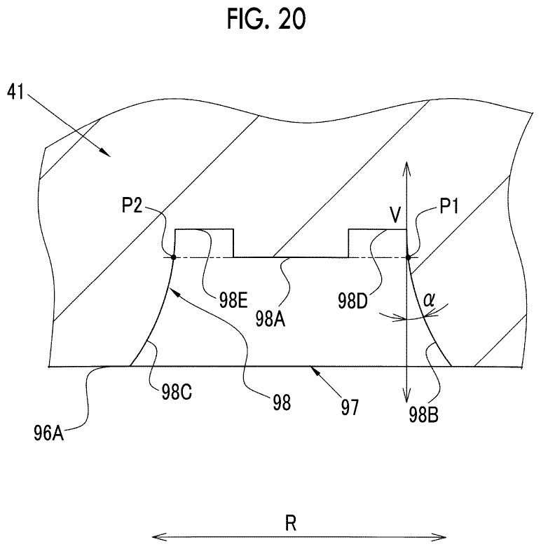

As shown in FIG. 20, the first recess portion 98 has a first surface part 98A and inclined parts 98B and 98C. The first surface part 98A is located radially outward with respect to the inner peripheral surface 96A of the ring member 96. It should be noted that FIG. 20 shows a state before the plating 97 is applied to the ring member 96.

The inclined part 98B is inclined with respect to the radial direction V of the ring member 96. Specifically, similarly to the inclined part 43B in the first embodiment, the inclined part 98B is inclined in the inner direction with respect to the radial direction V at an inclination angle α of 5° or more and 30° or less.

The inclined part 98C is also inclined in the inner direction with respect to the radial direction V at the inclination angle α of 5° or more and 30° or less, as in the inclined part 98B. In addition, the inclined parts 98B and 98C have a curved shape, similarly to the inclined parts 43B and 43C according to the above-described first embodiment.

Second recess portions 98D and 98E formed in the first recess portion 98. The second recess portions 98D and 98E are recess portions that are recessed radially outward with respect to the first surface part 98A. The second recess portions 98D and 98E are formed at both end parts of the first surface part 98A in the circumferential direction R. Reference numerals P1 and P2 denote positions at which the surface including the first surface part 98A and the inclined parts 98B and 98C intersect with each other. The second recess portions 98D and 98E are formed at positions including the positions P1 and P2. It should be noted that the present invention is not limited to this, and only one of the second recess portion 98D or the second recess portion 98E may be formed at the end part of the first surface part 98A in the circumferential direction R.

In addition, as in the first recess portion 43 according to the first embodiment, in the first recess portion 98, a dimension of the first surface part 98A is smaller than a dimension in a circumferential direction R of the ring member 96, which is a dimension of an inlet portion in contact with the inner peripheral surface 96A of the ring member 96. In the examples shown in FIGS. 19 and 20, the second recess portions 98D and 98E are groove portions having a rectangular cross section, but may be groove portions having a V-shaped or U-shaped cross section.

A step of manufacturing the zoom ring 95 is the same as the step of manufacturing the zoom rings 23 and 90 according to the first and second embodiments, and the zoom ring 95 is manufactured by the MID process. That is, the plating 97 is formed in the first recess portion 98 of the ring member 96 by performing each of the steps of injection molding, catalyst deactivation treatment, removal of a part of the thin film, the first recess portion formation, the catalyst application, and electroless plating. It should be noted that, in this case, in a step of forming the first recess portion 98, a step of forming the inclined parts 98B and 98C and the second recess portions 98D and 98E is also performed. The step of forming the inclined parts 98B and 98C and the second recess portions 98D and 98E is the same as the step in the first and second embodiments.

As described above, in the zoom ring 90, the first recess portion 98 has the inclined parts 98B and 98C, and the second recess portions 98D and 98E that are recessed radially outward with respect to the first surface part 98A of the first recess portion 98 are formed. Therefore, the same effects as in the first and second embodiments can be obtained, that is, the accuracy of the plating 97 with respect to the first recess portion 98 can be improved, and the pattern having a fine high reflective portion and a fine low reflective portion can be formed. Therefore, in a case in which the zoom ring 95 is rotated, the sensor 36 can detect the rotation position of the zoom ring 95 with a high resolution.

In addition, by forming the pattern formed on the zoom ring 95 with the plating 97, the same effects as in the first and second embodiments, such as the size reduction of the lens barrel 12, the cost reduction, ease of steps, and reduction in the number of steps, can be obtained.

### Fourth Embodiment

Although, in the above-described embodiments, the surface shapes of pieces of the plating 42, 92, and 97 formed in the first recess portions 43, 93, and 98 are not limited, the plating formed in the first recess portion and the inner peripheral surface of the ring member are located on the same surface in a fourth embodiment described later.

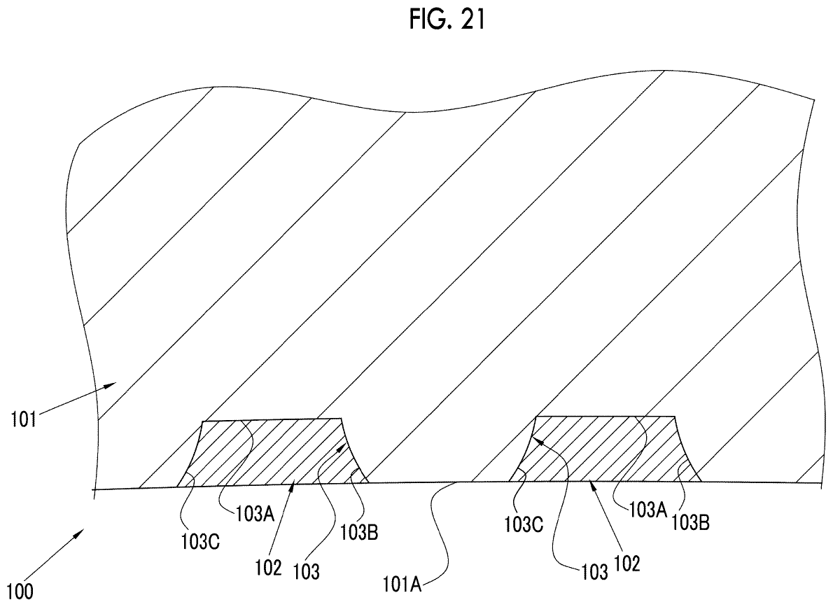

As shown in FIG. 21, a zoom ring 100 according to the present embodiment comprises a ring member 101 and plating 102. The zoom ring 100 corresponds to an operation ring in the claims. As in the above-described embodiments, in the zoom ring 100, the plating 102 is applied to the ring member 101, and thus the pattern that serves as the indicator for the rotation operation is formed on an inner peripheral surface 101A. It should be noted that the zoom ring 100 is the same as the zoom rings 23, 90, and 95 according to the above-described embodiments except for the surface shape of the plating 102, and the other configurations and the manufacturing step are also the same as those in the above-described embodiments, so the description thereof will be omitted.

A first recess portion 103 is formed in the ring member 101. Similarly to the first recess portion 43 according to the first embodiment, the first recess portion 103 is a recess portion that has a first surface part 103A and inclined parts 103B and 103C, is recessed radially outward with respect to the inner peripheral surface 101A, and has the same shape as the first recess portion 43. It should be noted that the shape of the first recess portion 103 is not limited to this, and the second recess portion may be formed as in the first recess portion 93 according to the second embodiment, or both the inclined part and the second recess portion may be formed as in the first recess portion 98 according to the third embodiment. The plating 102 is formed by metalizing the electroless plating catalyst through an electroless plating treatment, similarly to pieces of the plating 42, 92, and 97 according to the above-described embodiments.

In the present embodiment, the surface of the plating 102 and the inner peripheral surface 101A of the ring member 101 are located on the same surface (state indicated by a solid line in FIG. 21). In a case in which the electroless plating catalyst and the reducing agent bulge from the inner peripheral surface of the ring member due to the surface tension (state indicated by a two-dot chain line), it is conceivable that the plating is formed into a curved surface such as a convex lens. In this case, since the light emitted from the sensor 36 is diffused on the surface of the plating, the detection accuracy of the rotation position may be affected. On the other hand, in the present embodiment, since the surface of the plating 102 is located on the same surface as the inner peripheral surface 101A of the ring member 101, the light emitted from the sensor 36 is not diffused. Therefore, the sensor 36 can detect the rotation position of the zoom ring 100 with a high resolution.

In addition, it is possible to further reduce the thickness of the zoom ring 100, and it is possible to achieve the size reduction of the lens barrel 12 and the reduction of the outer diameter thereof. As the method of locating the surface of the plating 102 and the surface of the ring member 101 on the same surface, the bulging of the electroless plating catalyst and the reducing agent need only be suppressed by forming the inclined part in the first recess portion as in the first embodiment and/or forming the second recess portion in the first recess portion as in the second embodiment.

In each of the above-described embodiments, the hardware structure of the processing units that execute various types of processing, such as the lens control unit 51 and the camera body control unit 61, is various processors as shown below. The various processors include a central processing unit (CPU), which is a general-purpose processor that executes software (program) and that functions as various processing units, a graphical processing unit (GPU), a programmable logic device (PLD), which is a processor having a circuit configuration changeable after the manufacture, such as a field programmable gate array (FPGA), and a dedicated electric circuit, which is a processor having a circuit configuration specifically designed to execute various types of processing.

One processing unit may be configured by one of these various processors, or may be configured by a combination of two or more same or different types of processors (for example, a plurality of FPGAs, a combination of a CPU and an FPGA, or a combination of a CPU and a GPU). In addition, a plurality of the processing units may be configured by one processor. As an example in which the plurality of processing units are configured by one processor, first, there is a form in which one processor is configured by a combination of one or more CPUs and software, and this processor functions as the plurality of processing units, as represented by a computer, such as a client or a server. Second, as typified by a system on a chip (SoC) or the like, there is a form in which a processor, which realizes the functions of the entire system including the plurality of processing units with a single integrated circuit (IC) chip, is used. As described above, various processing units are configured by one or more of the various processors described above, as the hardware structure.

Further, the hardware structure of these various processors is, more specifically, an electric circuit (circuitry) in a form of a combination of circuit elements, such as semiconductor elements.

It should be noted that, in each of the above-described embodiments, an example has been described in which the present invention is applied to the zoom ring as the operation ring, but the present invention is not limited to this, and the present invention may be applied to the focus ring. The lens device according to the embodiment of the present invention can be applied to a lens barrel of a smartphone, a video camera, or the like, in addition to the lens barrel of the digital camera.

### EXPLANATION OF REFERENCES

10: digital camera
11: camera body
11A: grip portion
12: lens barrel
13: lens mount
13A: imaging aperture
14: release switch
16: imaging element
17: body-side signal contact
21: lens barrel body
21A: opening portion
22: imaging optical system
22A: filter
22B: first lens group
22C: second lens group
22D: stop
22E: third lens group
22F: fourth lens group
22G: fifth lens group
22H: stop aperture
23, 90, 95, 100: zoom ring
24: focus ring
25: electric zoom mechanism
26: focus mechanism
27: lens mount
28: lens-side signal contact
29: attachment member
31: lens holding frame
32: guide shaft
33: lead screw
33A: screw
34: motor
35: zoom carriage
35A: rack gear
36: sensor
36A: a light-emitting diode (LED)
36B, 36C, 36D: light-receiving integrated circuit (IC)
37: lens holding frame
38: sensor
41, 91, 96, 101: ring member
41A: inner peripheral surface
41B: outer peripheral surface
42, 92, 97, 102: plating
43, 93, 98, 103: first recess portion
43A: first surface part
43B, 43C: inclined part
44: pattern
51: lens control unit
52: motor driver
53: voice coil motor (VCM) driver
61: camera body control unit
62: shutter unit
63: shutter motor
64: motor driver
65: image memory
66: busline
67: image data processing unit
68: display driver
69: image display unit
71: card interface (I/F)
72: memory card
81: thin film
82: laser
83: electroless plating catalyst
91A: inner peripheral surface
93: first recess portion
93A: first surface part
93B, 93C: side surface
93D, 93E: second recess portion
96A: inner peripheral surface
98A: first surface part
98B, 98C: inclined part
98D, 98E: second recess portion
101A: inner peripheral surface
103A: first surface part
103B, 103C: inclined part
L1, L2: dimension
OA: optical axis
P: phase
P1, P2: position
R: circumferential direction
S: space
S11 to S15: step
T1, T2: width
V: radial direction
Vout1, Vout2: two-phase signal
α: inclination angle

What is claimed is:

1. An operation ring comprising:
a ring member;
a first recess portion that is formed in the ring member; and
plating that is applied to the first recess portion,
wherein an inclined part is formed in the first recess portion,
a plurality of the first recess portions are formed on an inner peripheral surface of the ring member, and
the plating is applied to the plurality of first recess portions and a pattern serving as an indicator of a rotation operation is formed on the inner peripheral surface.

2. The operation ring according to claim 1,
wherein the inclined part is inclined in an inner direction with respect to a radial direction at an inclination angle of 5° or more and 30° or less.

3. The operation ring according to claim 1,
wherein the inclined part has a curved shape.

4. The operation ring according to claim 1,
wherein a material of the operation ring is a carbon fiber composite material.

5. The operation ring according to claim 1,
wherein, in the pattern, portions to which the plating is applied are disposed at an equal interval in a circumferential direction of the operation ring.

6. The operation ring according to claim 5,
wherein the equal interval is an interval of 0.2 mm or more and 0.3 mm or less.

7. An operation ring comprising:
a ring member;
a first recess portion that is formed in the ring member; and
plating that is applied to the first recess portion,
wherein an inclined part is formed in the first recess portion,
the first recess portion has a first surface part that is located radially outward with respect to an inner peripheral surface of the ring member, and a second recess portion that is recessed radially outward with respect to the first surface part is formed.

8. The operation ring according to claim 7,
wherein the second recess portion is a groove portion formed at an end part of the first surface part in a circumferential direction.

9. The operation ring according to claim 7,
wherein the second recess portions are formed at both end parts of the first surface part in a circumferential direction.

10. The operation ring according to claim 8,
wherein the second recess portion includes a position at which a surface including the first surface part and the inclined part intersect with each other.

11. The operation ring according to claim 7,
wherein the inclined part is inclined in an inner direction with respect to a radial direction at an inclination angle of 5° or more and 30° or less.

12. The operation ring according to claim 7,
wherein the inclined part has a curved shape.

13. The operation ring according to claim 7,
wherein, in the first recess portion, a dimension of the first surface part is smaller than a dimension in a circumferential direction of the ring member, which is a dimension of an inlet portion in contact with the inner peripheral surface of the ring member.

14. The operation ring according to claim 7,
wherein a material of the operation ring is a carbon fiber composite material.

15. A lens device comprising:
an operation ring;
an optical system; and
an electric zoom mechanism that drives a zoom lens group that is a part of the optical system, in accordance with rotation of the operation ring,
wherein the operation ring includes:
a ring member;
a first recess portion that is formed in the ring member; and
plating that is applied to the first recess portion, and
wherein an inclined part is formed in the first recess portion.

16. The lens device according to claim 15,
wherein the optical system includes at least the zoom lens group, a first lens group, a filter, and a stop,
the filter has a maximum outer diameter portion larger than a maximum outer diameter portion of the first lens group and is located on a subject side with respect to the first lens group,
the zoom lens group is located between the first lens group and the stop and on the subject side with respect to the stop, and
the pattern is located between the maximum outer diameter portion of the first lens group and the maximum outer diameter portion of the filter.

17. An operation ring comprising:
a ring member;
a first recess portion that is formed in the ring member; and
plating that is applied to the first recess portion,
wherein an inner peripheral surface of the ring member and the plating are located on the same surface.

18. The operation ring according to claim 17,
wherein a plurality of the first recess portions are formed on the inner peripheral surface of the ring member, and
the plating is applied to the plurality of first recess portions and a pattern serving as an indicator of a rotation operation is formed on the inner peripheral surface.

19. A method of manufacturing an operation ring, the method comprising:
forming a first recess portion in a ring member;
forming an inclined part in the first recess portion; and
applying plating to the first recess portion.
